(19) United States
(12) Patent Application Publication
(10) Pub. No.: US 2021/0308493 A1
(43) Pub. Date: Oct. 7, 2021

(54) REUSABLE LIGHTWEIGHT RESPIRATOR MASK

(71) Applicant: Breathe99 LLC, Minneapolis, MN (US)

(72) Inventors: Max Bock-Aronson, Minneapolis, MN (US); Daniel Casey Johnson, Minneapolis, MN (US); Greg Lee Hoepfner, Minneapolis, MN (US)

(21) Appl. No.: 17/221,747

(22) Filed: Apr. 2, 2021

Related U.S. Application Data
(60) Provisional application No. 63/004,228, filed on Apr. 2, 2020.

(51) Int. Cl. A62B 7/10; A62B 23/02; A62B 18/02

(52) U.S. Cl. CPC A62B 7/10; A62B 18/084; A62B 18/025; A62B 23/02

(57) ABSTRACT

A respirator mask is described that includes a facepiece defining a hinge region. The facepiece is configured to create a seal with a face of a user. First and second mask substrates are spaced apart from one another and positioned on opposite sides of the hinge region. First and second filters are positioned adjacent the first and second mask substrates, respectively. First and second filter caps are configured to secure the first and second filters, respectively, to the facepiece.

### BACKGROUND

Outdoor air pollution is becoming an increasingly severe environmental health risk. People who are exposed to common outdoor pollutants including ozone, particulate matter, and nitrogen dioxide experience an increased risk of developing chronic respiratory diseases, ischemic heart attack, and stroke. Those who have decreased lung function such as children and seniors experience even higher rates of air pollution related morbidities.

There are numerous types of reusable respirators worn by people in work environments with contaminated air. While these respirators can be effective at filtering airborne pollutants, they can be large, heavy, and unattractive. As such, these devices are generally overly cumbersome for everyday protection, forcing the general public to find alternative options.

In general, three types of respiratory protection are currently worn by the general public: low protection cloth and paper masks, filtering facemasks, and reusable cloth masks with replaceable filters. Low protection cloth and paper masks are effective at reducing the spread of germs, however are not designed to filter small pollutants that can be harmful to lung health. Filtering facemasks are effective at filtering most harmful pollutants; however, they are intended for use in industrial settings and as such, are neither aesthetic, adjustable, or customizable. Reusable cloth masks with replaceable filters offer good protection and are designed for use by the general public. A drawback of these masks is that they don't provide a seal around the nose and mouth which results in two issues: (1) buildup of condensation that creates fogging of glasses, and (2) large, expensive filters. To reduce costs, many wearers of reusable fabric masks use the disposable filters much longer than their recommended efficient filter life, which reduces the efficacy of the mask and exposes the user to harmful air.

### SUMMARY

A respirator mask is described that includes a facepiece defining a hinge region. The facepiece is configured to create a seal with a face of a user. First and second mask substrates are spaced apart from one another and positioned on opposite sides of the hinge region. First and second filters are positioned adjacent the first and second mask substrates, respectively. First and second filter caps are configured to secure the first and second filters, respectively, to the facepiece.

### BRIEF DESCRIPTION OF THE DRAWINGS

FIG. 1 is a perspective view of a respirator mask.

FIG. 2 is a front perspective view of a mask assembly.

FIG. 3 is a rear perspective view of the mask assembly of FIG. 2.

FIG. 4 is a front view of a mask substrate.

FIG. 5 is a front perspective view of a facepiece.

FIG. 6 is a front perspective view of a filter cup.

FIG. 7 is a front perspective view of a filter.

FIG. 8 is a front perspective view of a filter cap.

FIGS. 9 and 10 are pictures of a mask assembly being held in a compact configuration.

FIGS. 11 and 12 are pictures of a respirator mask being held in a compact configuration.

### DESCRIPTION

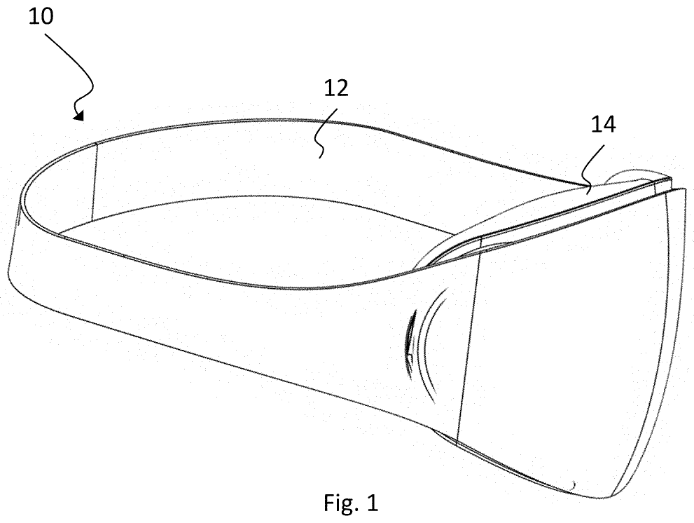

As illustrated in FIG. 1, a respirator mask 10 includes a fabric body 12 and a mask assembly 14. The fabric body 12 is connected with the mask assembly 14 to hold the mask assembly 14 to a face of a user. In one embodiment, the fabric body 12 includes a thin, semi-rigid plastic lining that provides structural integrity. Additionally, the fabric body 12 can include a connection mechanism (e.g., loops, buttons, magnets) to connect the fabric body 12 to the mask assembly 14. The fabric body 12 can be comprised of different textile materials as desired. In one embodiment, multiple materials of the fabric body 12 are attached using sewing and other bonding techniques such as radiofrequency or ultrasonic welding. Example textile materials include one or more of Lycra™, Tencel™, polyester, polypropylene, cotton, X-Static™ and/or combinations thereof. In one example, the material for fabric body 12 is selected to exhibit breathability as well as include moisture and odor-reducing properties. Straps of the fabric body 12 can loop behind a user's ears to provide retention for the mask assembly 14 against a user's face. In addition, the straps can be adjusted either manually using a standard buckle or automatically using a self-adjusting system.

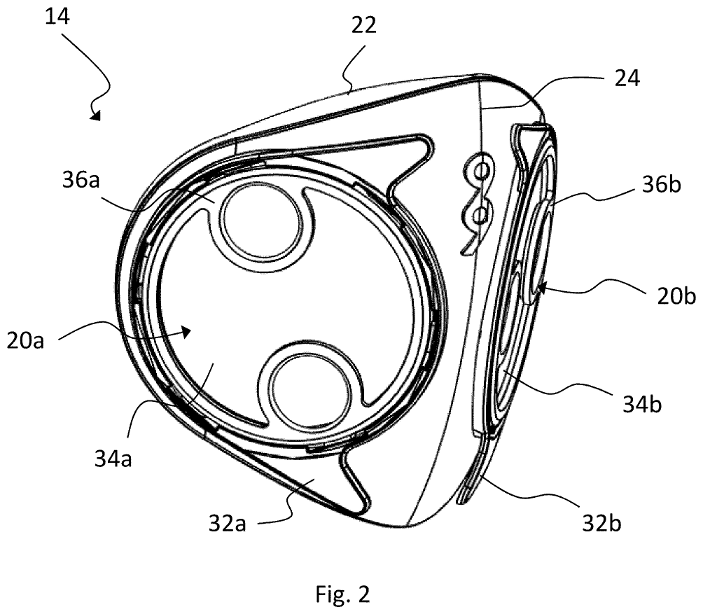

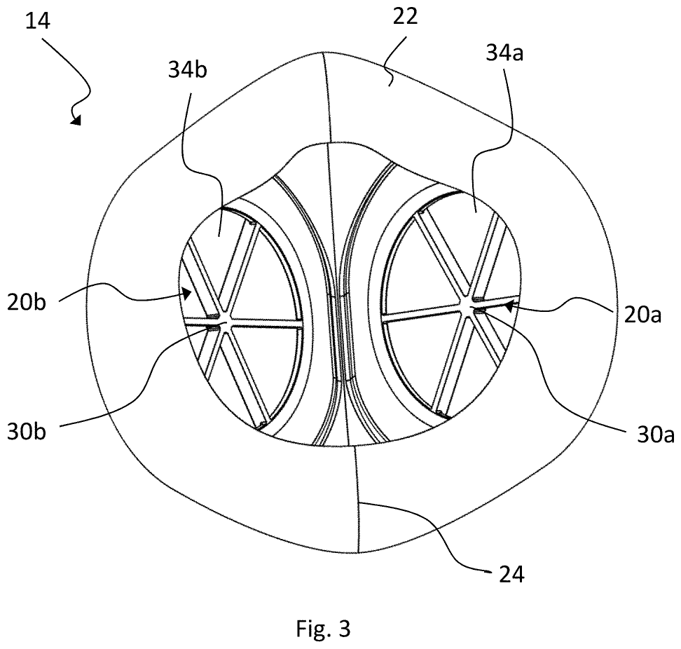

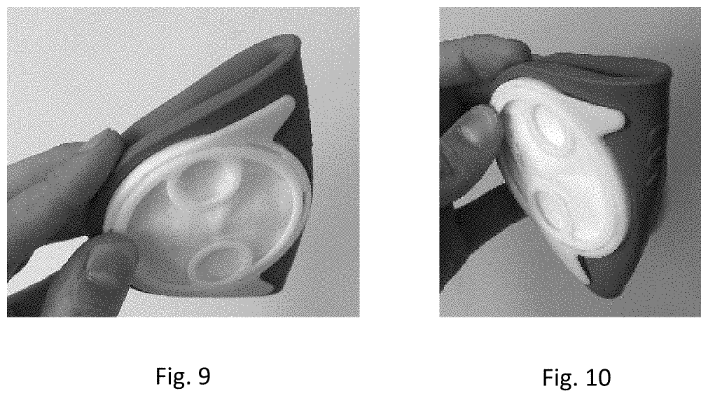

With further reference to FIGS. 2 and 3, the mask assembly 14 includes first and second port assemblies 20a and 20b and a facepiece 22. Port assemblies 20a and 20b are configured as inhalation ports that operate to filter air from outside the mask assembly 14 that is inhaled by a user. In the embodiment illustrated, mask assembly 14 does not include an exhalation port, although one or more exhalation ports can be positioned in the mask assembly 14 as desired. Port assemblies 20a and 20b are spaced apart from one another and positioned on either side of the facepiece 22 about a hinge region 24. Hinge region 24 allows mask assembly 14 to be transitioned from a first, expanded configuration (illustrated in FIGS. 2 and 3) to a second, compact configuration (illustrated in FIGS. 9-12). In the expanded configuration, major planar surfaces of the port assemblies 20a and 20b (oriented perpendicular to a direction of airflow through the port assemblies 20a and 20b) are oriented between 80 and 100 degrees apart from one another. In a more specific embodiment, this orientation can be between 85 and 95 degrees, approximately 90 degrees, approximately 87 degrees and other angular relationships as desired.

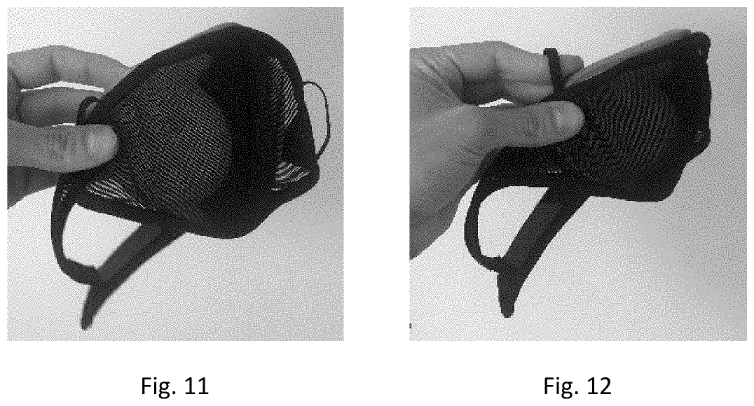

FIGS. 9 and 10 illustrate the mask assembly 14 being held in the compact configuration. In the compact configuration, major planar surfaces of the port assemblies 20a and 20b are rotated toward one another such that the port assemblies 20a and 20b are oriented parallel to one another. In the compact configuration, the mask assembly 14 can be easier to store and/or carry. For example, the mask assembly 14 can be placed in a pocket or a pouch while not in use. FIGS. 11 and 12 illustrate the respirator mask 10 in the compact configuration, with the fabric body 12 surrounding the mask assembly 14. In further embodiments, the respirator mask 10 can include mechanisms and/or features that hold the mask assembly 14 in the compact configuration. For example, the facepiece 22 can include corresponding attachment mechanisms on an inner part of the facepiece (e.g., buttons). In another embodiment, the fabric body 12 can include a pocket or strap that operates to hold the mask assembly 14 in the compact configuration.

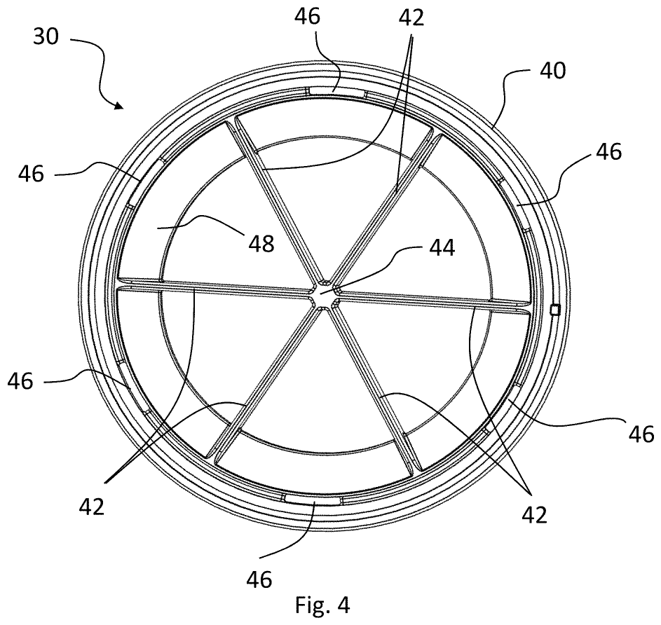

Port assembly 20a includes a mask substrate 30a, a filter cup 32a, a filter 34a and a filter cap 36a. In similar manner, port assembly 20b includes a mask substrate 30b, a filter cup 32b, a filter 34b and a filter cap 36b. In one embodiment, each of the components of the port assemblies are rotationally symmetric and thus can be positioned on either side of the hinge region 24 To assemble mask assembly 14, the mask substrates 30a and 30b can be loaded into a molding tool. Subsequently, the facepiece 22 can be overmolded onto the mask substrates 30a and 30b. Once the mask substrates 30a and 30b are assembled, filter cups 32a and 32b can be secured to the mask substrates 30a and 30b, respectively. In one embodiment, filter cups 32a and 32b are ultrasonically welded to respective mask substrates 30a and 30b, respectively. The filter cups 32a and 32b are positioned on an opposite side of the facepiece 22. Filters 34a and 34b can then be positioned in the filter cups 32a and 32b, respectively. Filter caps 36a and 36b then are positioned over the filters 34a and 34b, respectively, and secured to respective filter cups 32a and 32b. Various components of the port assemblies 20a and 20b along with facepiece 22 are described in further detail below with respect to FIGS. 4-8.

FIG. 4 illustrates mask substrate 30, which includes an outer annular rim 40 and a plurality of radial spokes 42 extending from the annular rim 40 to a central hub 44. In one embodiment, the mask substrate 30 is a unitary body formed of a rigid plastic (e.g., acrylonitrile butadiene styrene) through an injection molding process. Annular rim 40 can include a plurality of apertures 46 radially positioned about the rim and sized to receive molding material therein from the facepiece 22. As a result, an integral gasket between the mask substrate 30 and the facepiece 22 can be created and further the mask substrate 30 can be secured to the facepiece 22. Annular rim 40 further can include an internally extending flange 48 providing further interface area between the mask substrate 30 and the facepiece 22.

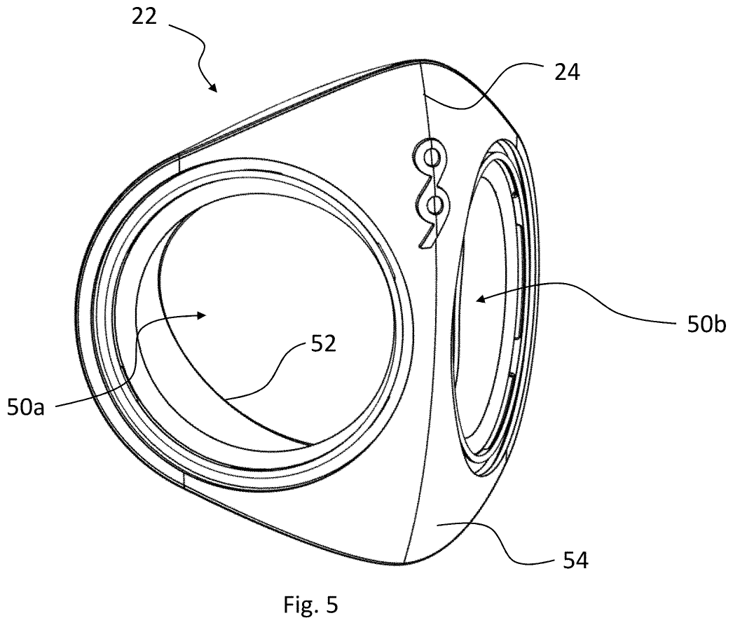

FIG. 5 illustrates facepiece 22, which is overmolded onto each of the mask substrates 30a and 30b. In one embodiment, the facepiece 22 is formed of a compliant material (e.g., a thermoplastic elastomer such as thermoplastic polyurethane or silicone) that can easily be folded about the hinge region 24 to transition the mask assembly 14 to the compact configuration. Upon forming facepiece 22, the facepiece includes openings 50a and 50b, an inner annular cushion surface 52 configured to create a seal with a user's face and an outer surface 54 configured to engage the fabric body 12. Openings 50a and 50b are formed around mask substrates 30a and 30b, respectively and allow passage of air from the outer surface 54 to a volume defined by the user's face and the internal annular cushion 52.

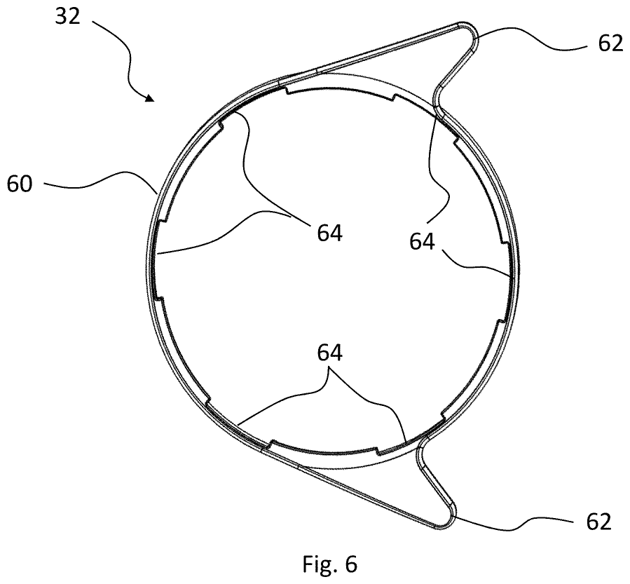

FIG. 6 illustrates a top view filter cup 32, which includes an annular rim 60 and two hooks 62 extending from the annular rim 60. In one embodiment, filter cup 32 is a unitary body formed of a rigid plastic (e.g., acrylonitrile butadiene styrene). Annular rim 60, in one embodiment, is ultrasonically welded to mask substrate 30 such that a portion of facepiece 22 is positioned between mask substrate 30 and filter cup 32. Hooks 62 can be used to grasp the filter cup 32 in various situations, such as during welding or coupling the filter cup 32 and the filter cap 36. Annular rim 60 further includes a plurality of recesses 64 configured to engage the filter cap 36.

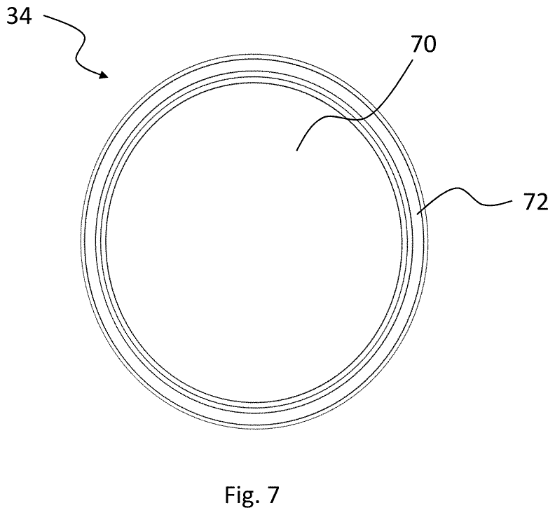

FIG. 7 illustrates a top view of filter 34. Filter 34 can be formed of various different filtration media as desired. In one embodiment, the filter 34 is made from high-efficiency, electrostatically charged filter media 70 that is sealed about a peripheral seal 72. The filter 34 can be die-cut to a round shape and heat sealed in a single step for ease of manufacture. Filter 34 can be replaced periodically depending on amount of use. During assembly, the filter 34 is placed in filter cup 32 and rests against the plurality of radial spokes 42 of the mask substrate 30.

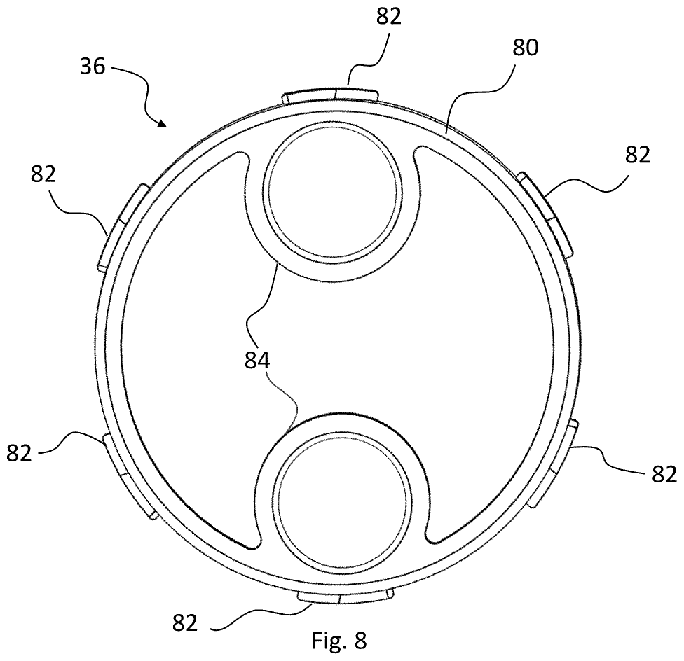

FIG. 8 illustrates filter cap 36, which includes an annular rim 80, a plurality of tabs 82 extending about the rim 80 and finger holes 84 extending internally from the annular rim 80. In one embodiment, filter cap 36 is a unitary body formed of a rigid plastic (e.g., acrylonitrile butadiene styrene). Tabs 82 are spaced to engage recesses 64 on the filter cup 32. In order to lock the filter 34 in place, the tabs 82 of the filter cap 36 are positioned within the recesses 64. The filter cap 36 can then be twisted (e.g., approximately a quarter turn) to lock the filter cap 36 to the filter cup 32. The finger holes 84 can be used to assist a user in operating to rotate the filter cap 36 with respect to the filter cup 32. In one embodiment, the filter cap 36 and filter cup 32 connection is a bayonet-style turn to lock mechanism that secures filter cap 36 to filter cup 32. Filter 34 is positioned between the filter cup 32 and the filter cap 36 and is thus locked in place within the mask assembly 14.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A respirator mask, comprising:
a facepiece defining a hinge region, the facepiece configured to create a seal with a face of a user;
first and second mask substrates spaced apart from one another and positioned on opposite sides of the hinge region;
first and second filters positioned adjacent the first and second mask substrates, respectively; and
first and second filter caps configured to secure the first and second filters, respectively, to the facepiece.

2. The respirator mask of claim 1, wherein the first and second mask substrates are rotationally symmetric.

3. The respirator mask of claim 1, wherein the first and second mask substrates are identical.

4. The respirator mask of claim 1, wherein the first and second mask substrates are formed of a rigid plastic.

5. The respirator mask of claim 1, wherein the facepiece is formed of a compliant thermoplastic elastomer.

6. The respirator mask of claim 1, wherein each of the first and second mask substrates include an annular rim having a plurality of apertures and further wherein the facepiece fills the plurality of apertures to form a gasket between the first and second mask substrates and the facepiece.

7. The respirator mask of claim 1, wherein each of the first and second filter caps include tabs configured to engage corresponding recesses.

8. The respirator mask of claim 1, wherein the facepiece can be transitioned from a first, expanded configuration to a second, compact configuration by rotating the first and second mask substrates about the hinge region.

9. The respirator mask of claim 1, further comprising a fabric body configured to hold the facepiece to a face of the user.

10. A method of forming a respirator mask, comprising:
forming a facepiece defining a hinge region;
positioning first and second mask substrates spaced apart from one another on opposite sides of the hinge region;
positioning first and second filters adjacent the first and second mask substrates, respectively; and
securing first and second filter caps to the first and second mask substrates, respectively.

11. The method of claim 10, wherein the first and second mask substrates are rotationally symmetric.

12. The method of claim 10, wherein the first and second mask substrates are identical.

13. The method of claim 10, wherein the first and second mask substrates are formed of a rigid plastic.

14. The method of claim 10, wherein the facepiece is formed of a compliant thermoplastic elastomer.

15. The method of claim 10, wherein each of the first and second mask substrates include an annular rim having a plurality of apertures and further wherein the facepiece fills the plurality of apertures to form a gasket between the first and second mask substrates and the facepiece.

16. The method of claim 1, wherein each of the first and second filter caps include tabs configured to engage corresponding recesses.

17. The method of claim 10, wherein the facepiece can be transitioned from a first, expanded configuration to a second, compact configuration by rotating the first and second mask substrates about the hinge region.

18. The method of claim 1, further comprising using a fabric body to hold the facepiece to a face of the user.
